(19) United States
(12) Patent Application Publication
(10) Pub. No.: US 2005/0211801 A1
(43) Pub. Date: Sep. 29, 2005

(54) Fuel injection device having hydraulic nozzle needle control

(76) Inventor: Theodor Tovar, Pocking (DE)

Correspondence Address: KATTEN MUCHIN ROSENMAN LLP, 575 MADISON AVENUE, NEW YORK, NY, 10022-2585, US

(21) Appl. No.: 10/508,633

(22) PCT Filed: Feb. 5, 2003
(86) PCT No.: PCT/EP03/01101

§ 371 Date: Sep. 17, 2004

(30) Foreign Application Priority Data
Mar. 26, 2002 (DE) 10213441.3

(51) Int. Cl. F02M 63/00

(52) U.S. Cl. 239/533.2

(57) ABSTRACT

The invention relates to a fuel injection device for diesel engines, which comprises an injection nozzle, a nozzle holder and a fuel high-pressure system. The fuel injection device has the following characteristics: The nozzle holder body (1) has a cavity (valve spring space) (26), which is connected to the fuel high-pressure system (12, 6) via a connecting line (27); the cavity is connected to the needle spring space (16) via a first pressure valve (18, 19) and a second pressure valve (21, 22); the first pressure valve opens to the needle spring space (16) and comprises a valve body (18) which is pressed by the spring force of the needle closing spring (14) onto its sealing seat (19) and can be lifted from its sealing seat (19) by the pressure inside the connecting line (27) whereby fuel flows from the valve spring space (26) into the needle spring space (16). The second pressure valve opens to the valve spring space (26) and comprises a valve body (21) which is pressed onto its sealing seat (22) by the spring force of a weak valve spring (23) that is increased by the pressure inside the connecting line (27), and said valve body can be lifted from its sealing seat (22) by the pressure of the fuel inside the needle spring space (16) whereby fuel flows from the needle spring space (16) into the valve spring space (26).

The present invention relates to a fuel-injection device for diesel engines, according to the features specified in the preamble of claim 1.

In internal-combustion engines with self-ignition, the fuel is injected into the combustion chambers via a fuel-injection system. This usually comprises an injection pump, which is in communication via a pressure line with a fuel-injection device, composed of nozzle holder and injection nozzle fixed thereto. The injection nozzle in turn is composed of a nozzle body provided with injection holes (nozzles) and a nozzle needle for closing the nozzles. The inlet line arriving from the injection pump opens into a pressure line, which guides the fuel under high pressure to the nozzles. The nozzle needle, which is disposed movably in axial direction, is urged against its sealing seat by the force of a needle-closing spring, but can be lifted from its sealing seat by a sufficiently high pressure of the fuel conveyed thereto via the pressure duct, so that fuel can pass through the nozzles into the combustion chamber. The fuel enters the combustion chamber in atomized form, where it becomes mixed with the compressed hot air present in the combustion chamber and ignites

In such conventional fuel-injection devices, it has proved to be disadvantageous if the fuel quantity introduced into the combustion chamber within the ignition delay time, or in other words the time between the beginning of injection and the beginning of combustion, burns in a very short time because of the rapidly rising pressures and temperatures. The high pressure spike that occurs at first in the combustion chamber causes noise emissions, which become increasingly intense as the fuel quantity introduced within the ignition delay time increases. Aside from this problem, another reason to strive for the lowest possible pressures and temperatures in the combustion chamber is to prevent the formation of environmentally harmful nitrogen oxides (NOₓ).

To avoid these drawbacks, it is advantageous to inject and burn only a little fuel at first during the top dead center of the crankshaft, and to increase the injection rate steadily only in the ensuing expansion phase, which is associated with a pressure and temperature drop. One approach to this objective is to impose a time delay on opening of the nozzles, as can be achieved by raising the nozzle-needle opening pressure, for example by increasing the spring constant of the needle-closing spring.

However, this method also results in considerable problems, since the time available for evaporation, mixing and burning the fuel introduced at the end of injection is particularly short, due to the mass inertia of the nozzle needle (including that of the thrust pin and a contribution due to the needle-closing spring). This fuel portion is therefore introduced into the combustion chamber with relatively low pressure, and so it is only poorly atomized. Unfortunately, large droplets mix only poorly with the compressed combustion air, and so combustion takes place only incompletely. As a consequence, the exhaust-gas emissions increase greatly, especially those of carbon monoxide (CO) soot particles and unburned hydrocarbons.

In contrast, the object underlying the present invention is to provide a fuel-injection device of the class in question wherein the injection rate is varied in such a way by control of the nozzle needle that, at the end of the injection cycle, the fuel is introduced into the combustion chamber at sufficiently high pressure to ensure good atomization. In the process, it is intended that the initial injection rate in no way be adversely impaired. In addition, it is intended that such control be achieved with little complexity.

This object is achieved according to the invention by the features of claim 1. Advantageous configurations of the invention are specified by the features of the dependent claims.

According to the invention, there is provided a fuel-injection device for diesel engines, which device comprises an injection nozzle as well as a nozzle holder fixed thereto. This injection nozzle is provided with a nozzle body and a nozzle needle guided axially movably along a sliding surface, as well as a nozzle-needle sealing seat provided with injection holes. The nozzle holder comprises a nozzle-holding body with a needle-spring space and a needle-closing spring disposed therein. To supply the injection holes with fuel, the fuel-injection device has a fuel high-pressure system, which is composed of a nozzle-side pressure line leading to the injection holes and a holder-side pressure line opening thereinto. In turn, the holder-side pressure line is in communication with an inlet line arriving from an injection pump.

The nozzle needle is on the one hand urged onto its sealing seat by the spring force of the needle-closing spring and is on the other hand lifted from its sealing seat when the pressure of the fuel conveyed thereto via the nozzle-side pressure line exceeds the spring force of the needle-closing spring, whereby fuel can reach the injection holes.

A characteristic feature of the present invention is that the nozzle-holding body is provided with a cavity (“valve-spring space”), which is in communication with the fuel high-pressure system via a connecting line and which is in communication with the needle-spring space via both a first pressure valve and a second pressure valve.

The first pressure valve, which opens toward the needle-spring space, is provided with a valve body, which on the one hand is urged onto its sealing seat by the spring force of the needle-closing spring and on the other hand is lifted from its sealing seat when the pressure of the fuel conveyed via the connecting line into the valve-spring space exceeds the spring force of the needle-closing spring. When the first pressure valve is opened, fuel can flow from the valve-spring space into the needle-spring space.

The second pressure valve, which in contrast to the first pressure valve opens toward the valve-spring space, is provided with a valve body, which on the one hand is urged onto its sealing seat by the weak spring force of a valve spring as well as by the pressure of the fuel conveyed into the valve-spring space via the connecting line, but on the other hand is lifted from its sealing seat when the pressure of the fuel in the needle-spring space exceeds these forces. When the second pressure valve is opened, fuel can flow from the needle-spring space back into the valve-spring space and a relative overpressure between needle-spring space and valve-spring space can be substantially equalized. Thus the second constant-pressure valve ensures that essentially the pressure in the needle-spring space is not higher than in the valve-spring space or in the fuel high-pressure system in communication therewith. The spring force of the valve spring urging the second constant-pressure valve is “weak”, meaning that a very small overpressure of the fuel in the needle-spring space relative to the valve-spring space is sufficient to open the second constant-pressure valve, thus allowing this overpressure to be equalized with the valve-spring space. The spring force of the valve spring is very much smaller than the spring force of the needle-closing valve and, for example, amounts to only a few per cent of the spring force of the needle-closing spring. The only important factor here is that the second constant-pressure valve be maintained in closed position as long as the fuel pressure in the needle-spring space is not higher than in the valve-spring space.

Because of the fuel pressure prevailing in the needle-spring space, the nozzle needle is additionally urged toward its sealing seat. Hereby a very fast closing movement of the nozzle needle is achieved. Furthermore, this movement begins even at a very high value of the fuel pressure. Because of the high fuel pressure toward the end of injection, the best conditions exist for intensive atomization of the fuel. This is favorable in particular with regard to the quantity of exhaust-gas emissions, which in this case contain primarily carbon monoxide (CO), soot particles and unburned hydrocarbons and which can be considerably diminished. For practical purposes, post-combustion dripping of fuel particles and blowback of exhaust gases no longer occur.

According to an advantageous embodiment of the invention, it is provided that the second constant-pressure valve is integrated in the first constant-pressure valve.

A preferred practical example of the invention will be explained hereinafter with reference to the drawings, wherein

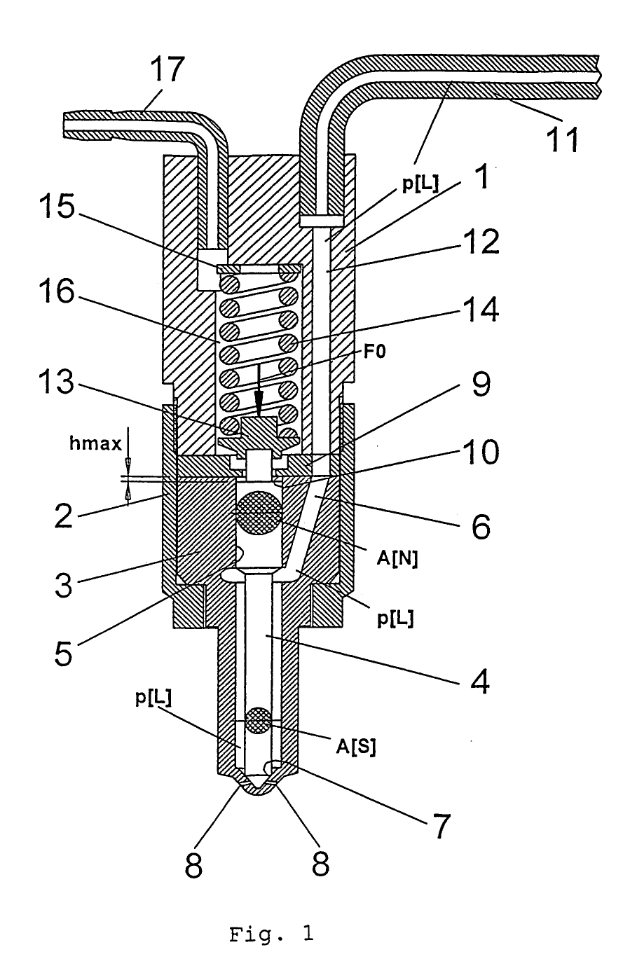

FIG. 1 shows a longitudinal section through a known prior-art fuel-injection device,

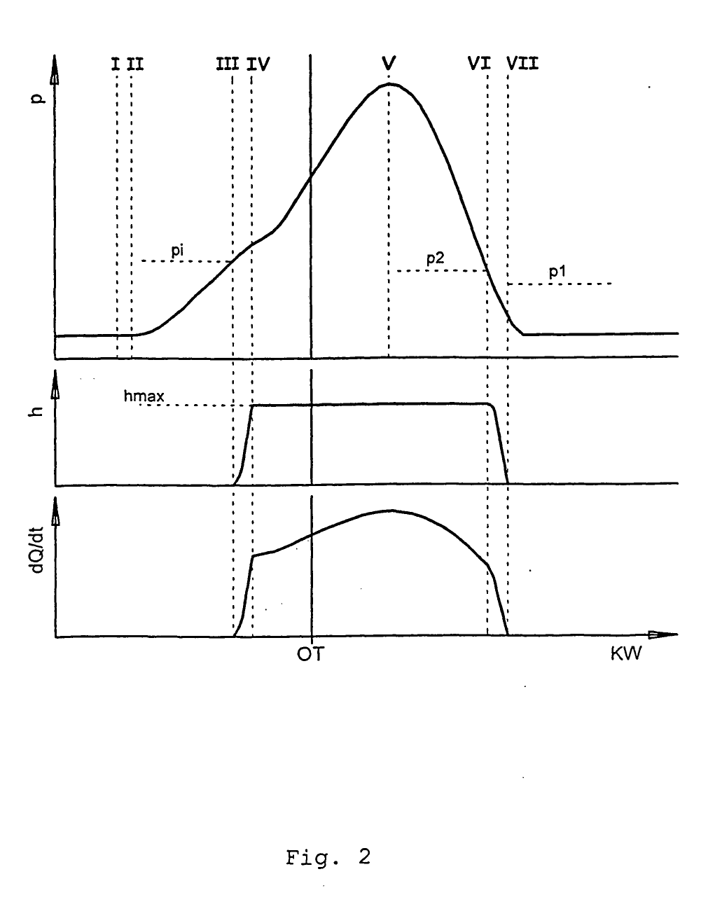

FIG. 2 shows three diagrams illustrating fuel pressure p, nozzle-needle stroke h and injection rate dQ/dt, each as a function of crank angle KW, for a known prior-art fuel-injection device according to FIG. 1,

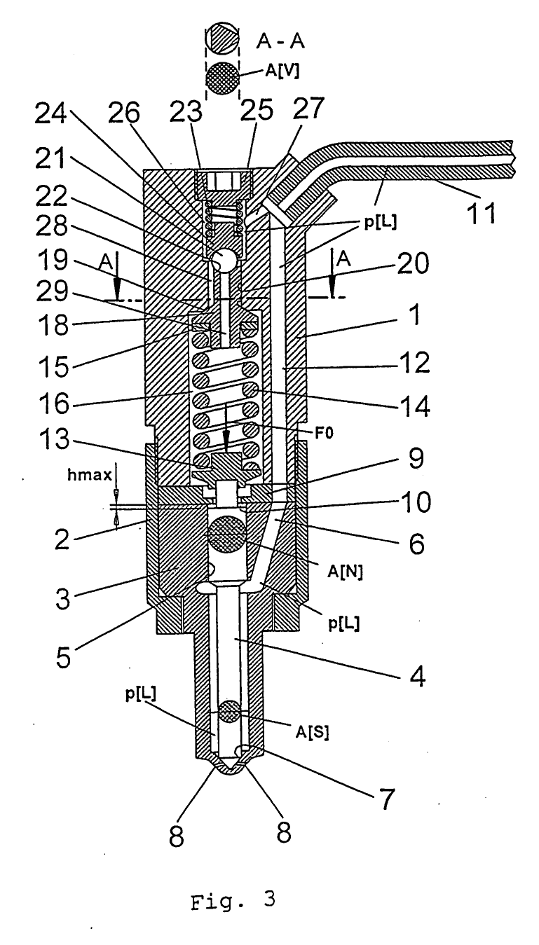

FIG. 3 shows a longitudinal section through a fuel-injection device according to the present invention,

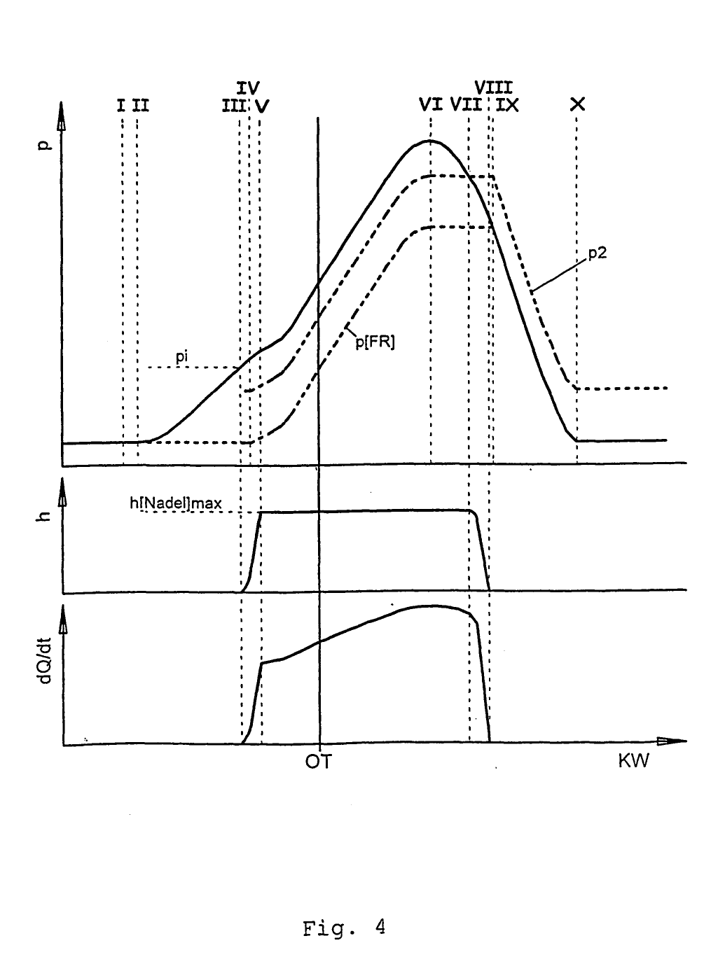

FIG. 4 shows three diagrams illustrating fuel pressure p, nozzle-needle stroke h and injection rate dQ/dt, each as a function of crank angle KW, for an inventive fuel-injection device according to FIG. 2,

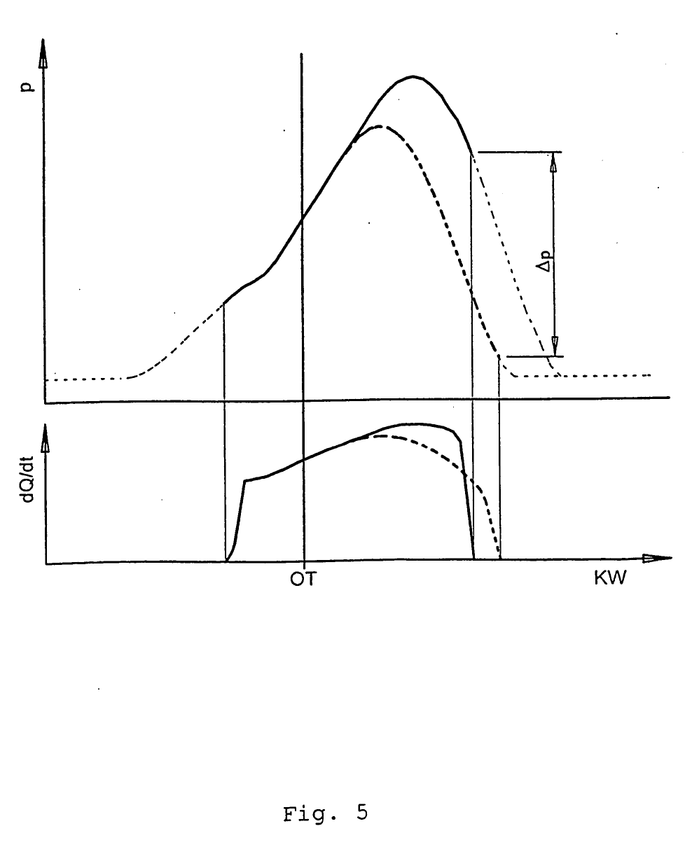

FIG. 5 shows two diagrams comparing fuel pressure p and injection rate dQ/dt, each as a function of crank angle KW, for a known prior-art fuel-injection device according to FIG. 1, and for an inventive fuel-injection device according to FIG. 2.

The known prior-art fuel-injection device according to FIG. 1 comprises a nozzle holder with nozzle-holding body 1 and, fixed thereon by means of a union nut 2, a nozzle body 3 of an injection nozzle. Nozzle-holding body 1 accommodates a needle-spring space 16 containing a needle-closing spring 14. In nozzle body 3 there is disposed a nozzle needle 4, which is urged onto its sealing seat 7 by the spring force of the preloaded needle-closing spring 14, which force acts through a thrust pin 13. Nozzle needle 4 is guided movably along sliding surface 5; in this region it has a cross-sectional area A[N]. Its travel movement h is limited by shoulder 10 of intermediate plate 9. At the lower end of nozzle needle 4 there is disposed its sealing seat 7, which is provided with the nozzles or injection holes 8 leading into the combustion chamber. At the level of its sealing seat 7, nozzle needle 4 has a cross-sectional area A[S].

When nozzle needle 4 is resting on its sealing seat 7, nozzles 8 are closed. If nozzle needle 4 is lifted, the fuel can pass from the high-pressure system composed of holder-side pressure line 12 and nozzle-side pressure line 6 via nozzles 8 into the combustion chamber. Holder-side pressure line 12 of nozzle-holding body 1 has the form of a bore, which at one end communicates with fuel inlet line 11 arriving from the injection pump in order to be supplied with fuel, and at the other end opens into nozzle-side pressure line 6 of the injection nozzle.

Needle-spring space 16 is in communication with a bleed-oil line 17, in order to return leaks to the fuel tank without backpressure.

The preload force F₀ of needle-closing spring 14 is adjusted in such a way by an adjusting disk 15 disposed in needle-spring 16 that the desired opening pressure pᵢ is obtained. This opening pressure pᵢ is defined as that pressure p in high-pressure system 12, 6 of the fuel-injection device which produces equilibrium of forces at nozzle needle 4 located on its sealing seat 7. This pressure acts on the annular area A[N]-A[S] and opposes the spring force of needle-closing spring 14. At equilibrium of forces, therefore, the following relationship is obeyed:
pᵢ·(A[N]-A[S])=F₀ (1)

If the pressure pᵢ is exceeded, nozzle needle 4 moves upward and fuel can enter the combustion chamber via nozzle 8. As soon as nozzle needle 4 is lifted, the pressure p is also present at the surface of sealing seat 7. From this there is obtained as a further characteristic variable the pressure p₁, which just prevents the nozzle from closing and is lower than pᵢ, since it acts on the entire cross-sectional area A[N] of the nozzle needle:
p₁·A[N]=F₀ (2)

As a third characteristic variable there is obtained the pressure p₂, which just holds the nozzle needle against the upper stop and additionally depends on the stiffness, or in other words on the spring constant, of needle-closing spring 14:
p₂·A[N]=F₀+D·hₘₐₓ (3)
where D denotes the spring constant of nozzle-closing spring 14 and hₘₐₓ the maximum stroke of nozzle needle 4.

FIG. 2 shows the fuel pressure p, nozzle-needle stroke h and injection rate dQ/dt, each as a function of the crank angle KW, for a fuel-injection device according to FIG. 1. OT denotes the top dead center of the crankshaft.

Before fuel delivery begins (I), the standing pressure prevails in high-pressure system 12, 6. This is the resting pressure that has become established at the end of the previous injection and that depends on the system design. In this connection there is no need to consider the magnitude of the standing pressure further.

From a predetermined time, or in other words when delivery begins (II), the fuel pump delivers fuel fed via fuel inlet line 11 of high-pressure system 12, 6 of the fuel-injection device. Since nozzle needle 4 is still resting on its sealing seat 7 and nozzles 8 are closed, the pressure p in high-pressure system 12, 6 rises. If the pressure p has risen so far that it exceeds the opening pressure pᵢ (III), nozzle needle 4 is lifted from its sealing seat 7 and fuel passes through nozzles 8 into the combustion chamber. Since pᵢ is higher than p₁ and normally also than p₂, nozzle needle 4 is moved at accelerating speed to its upper stroke stop (IV), which corresponds to the maximum stroke hₘₐₓ.

Since, in conventional fuel-injection devices, more fuel is delivered by the injection pump than can be dispensed by the nozzles, the pressure p continues to rise. Fuel delivery then ceases at a predetermined time, or in other words the end of delivery (V). From this time on, the pressure is continuously reduced via nozzles 8 and the injection pump.

If the pressure p has dropped so far that it is below p₂ (VI), nozzle needle 4 begins to move at accelerating speed toward its sealing seat 7, as a result of the predominating spring force of nozzle-closing spring 14. When the pressure p ultimately becomes smaller than p₁, nozzle needle 4 rests on its sealing seat 7 once again and closes nozzles 8.

From FIG. 2 it is evident that the sealing seat of the needle-closing spring is not reached until a late stage, namely at the end of injection (VII), where the pressure p has already dropped far below p₁. As a consequence, the fuel is burned only incompletely at the end of injection, due to poor atomization.

In the inventive fuel-injection device according to FIG. 3, components identical to those of the known prior-art fuel-injection device according to FIG. 1 are denoted by like reference numerals. There is therefore no need to repeat the description of these components.

In the inventive fuel-injection device, there is disposed in the upper region of nozzle-holding body 1 a cavity 26 (“valve-spring space”), which is in communication with fuel high-pressure system 12, 6 via a connecting line 27. Valve-spring space 26 is also in communication with the needle-spring space via a first pressure valve 18, 19 and a second pressure valve 21, 22 integrated in the first pressure valve.

The first pressure valve, which opens toward needle-spring space 16, is provided with a valve body 18, which is urged onto its sealing seat 19 by the spring force of needle-closing spring 14. Between needle-spring space 16 and valve-spring space 26, valve body 18 of the first constant-pressure valve is prolonged by a shaft 20, which is provided on its outside with grooves 28.

The second pressure valve comprises a bore 29, which extends through valve body 18 and shaft 20 and which is open toward needle-spring space 16, but is closed toward valve-spring space 26 by a ball 21 urged against its sealing seat 22 by the weak spring force of a valve spring 23. Valve spring 23 urging ball 21 is disposed in valve-spring space 26, and is braced on the one hand against a thrust pin 24, which rests on ball 21, and on the other hand against a sealing plug 25, which seals valve-spring space 26 from the outside.

If fuel is conveyed via fuel inlet line 11, holder-side fuel pressure line 12 and connecting line 27 into the valve-spring space by delivery from a fuel pump, the fuel passes via slots 28 of shank 20 to sealing seat 19 of valve body 18 of the first constant-pressure valve. Thus the fuel pressure p is present at first constant-pressure valve 18, 19. If the fuel pressure exceeds the spring force of needle-closing spring 14, valve body 18 is lifted from its sealing seat 19, and fuel flows from valve-spring space 26 into needle-spring space 16.

Ball 21 of second constant-pressure valve 21, 22 is on the one hand urged onto its sealing seat 22 by the weak spring force of valve spring 23 and additionally by the pressure of the fuel conveyed thereto via connecting line 27. On the other hand, the pressure of the fuel in needle-spring space 16 is present at ball 21 via bore 29, which is open toward needle-spring space 16. If the pressure of the fuel in the needle-spring space is so high that it exceeds the spring force of valve spring 23 and the pressure of the fuel conveyed thereto via connecting line 27, ball 21 is lifted from its sealing seat 22 and fuel flows from needle-spring space 16 back into valve-spring space 26. Hereby a relative overpressure between needle-spring space and valve-spring space can be substantially equalized.

If both the first constant-pressure valve and the second constant-pressure valve are closed, needle-spring space 16 is sealed off toward the outside. A pressure known as the needle-spring-space pressure (p[FR]) then prevails in needle-spring space 16 and, adding to the spring force of needle-closing spring 14, it urges nozzle needle 4 toward its sealing seat 7. Therewith the conditions for opening and closing nozzle needle 4 are changed, since the p[FR] acting on the cross-sectional area A[N] exerts a force in the same direction as the spring force of the needle-closing spring. The opening condition of nozzles 8 is represented by the following equilibrium of forces:
pᵢ·(A[N]-A[S])=F₀+p[FR]·A[N] (4)

If the same initial conditions exist during fuel injection as is the case in the known fuel-injection device according to FIG. 1, the spring force F₀ must be adjusted to a correspondingly smaller value.

The characterizing variables “closing of nozzles 8” and “beginning of closing movement of nozzle needle 4”, or in other words p₁ and p₂, are now dependent on p[FR] and are represented by the following relationships:
p₁·A[N]=F₀+p[FR]·A[N] (5)
p₂·A[N]=F₀+D·hₘₐₓ+p[FR]·A[N] (6)

To determine p[FR], it is necessary to consider the equilibrium of forces established at the first constant-pressure valve as a result, on the one hand, of the pressure acting on the cross section A[V] of sealing seat 19 and the spring force F₀ of needle-closing valve 14 and, on the other hand, of the fuel pressure p acting on the cross-sectional area A[V]:
p·A[V]=F₀+p[FR]·A[V] (valid for p₁) (7)
p·A[V]=F₀+D·hₘₐₓ+p[FR]·A[V] (valid for p₂) (8)

If the fuel pressure p is higher than the value necessary for equilibrium, valve body 18 of the first constant-pressure valve is lifted from its seat 19 and fuel enters needle-spring space 16. As a result, the pressure p[FR] in needle-spring space 16 rises, until equilibrium is reestablished. The fuel quantity flowing into needle-spring space 16 has negligible influence on injection into the combustion chamber, in view of the very small quantity of fuel flowing into needle-spring space 16.

In analyzing the end of injection, only equation 8 is relevant, since it yields the maximum achievable pressure p[FR]. From (8), p[FR] is obtained as
p[FR]=p−(F₀−D·hₘₐₓ)/A[V] (9)

Inserting equation (9) in (5) and (6) yields:
p₁=p−(1/A[V]−1/A[N])·F₀ (10)
p₂=p−(1/A[V]−1/A[N])·F₀−D·hₘₐₓ/A[V] (11)

In contrast to the prior-art fuel injection device, therefore, p₁ and p₂ increase with fuel pressure p.

By analogy with FIG. 2, which corresponds to the case of the known prior-art fuel-injection device, FIG. 4 shows the fuel pressure p, needle stroke h and injection rate dQ/dt, each as a function of crank angle KW, for the inventive fuel-injection device. In addition to the fuel pressure p, the pressure p[FR] in the needle-spring space and the pressure p₂ for equilibrium are plotted.

Before injection (I), the standing pressure that has become established at the end of the previous injection prevails in high-pressure system 12, 6 and in needle-spring space 16. When fuel delivery begins (II), the pressure p rises. If the pressure p has exceeded the value of pᵢ, nozzle needle 4 is lifted from its sealing seat 7 (III) and is moved at accelerating speed to its upper stop (V), since the pressure p is greater than p₂. From (IV) on, the first constant-pressure valve opens and fuel flows into needle-spring space 16. As a result, the pressure p[FR] in needle-spring space rises with the fuel pressure p. This has the consequence that p₁ and especially p₂ also rise. Delivery is ended at (VI), whereby the fuel pressure p drops again. However, the pressure in needle-spring space 16 remains constant, and thus so also do p₁ and p₂. If the fuel pressure p drops below the pressure p₂, nozzle needle 4 begins its closing movement (VII). At (VIII), nozzle needle (4) is again seated on its sealing seat 7, thus closing nozzles 8 and ending injection. If the fuel pressure p drops below the value of p[FR] at IX, fuel flows via the ball valve from needle-spring space 16 into valve-spring space 26, and p[FR] drops with p until a standing pressure that depends on the system design is present both in high-pressure system 12, 6 and in needle-spring space 16.

Finally, FIG. 5 shows a direct comparison of fuel pressure p and injection rate dQ/dt of the known prior art fuel-injection device according to FIG. 1 (dashed lines) and of the fuel-injection device of the present invention according to FIG. 3 (solid lines). A correspondingly smaller spring constant of needle-closing spring 14 was chosen for the inventive fuel-injection device, so that fuel pressure and injection rate are equal in both fuel-injection devices at the beginning of delivery (solid lines). At a crank angle above OT (top dead center), the plot of these two characteristic variables differs distinctly. For the inventive fuel-injection device, a much higher fuel-pressure is established on the whole; moreover, the end of fuel delivery is shifted to a higher crank angle. Because nozzle needle 4 in the inventive fuel-injection device returns to its sealing seat 7 much earlier and at a higher fuel pressure p, the injection rate undergoes a steeper drop. At the end of the injection process, the fuel pressure in the inventive fuel-injection device is higher by a magnitude of Δp, thus meeting the prerequisite for much better atomization of the fuel.

On the whole, therefore, it will be noted that, in the case of the inventive fuel injection as compared with the fuel-injection device known in the prior art, an equal quantity of fuel is injected in a narrower range of crank angle at a fuel pressure that is usually higher on the whole, so that a much higher fuel pressure exists in particular at the end of fuel delivery. By virtue of the better atomization of the fuel, the emissions of CO, soot and unburned hydrocarbons can be considerably reduced.

1. A fuel-injection device for diesel engines, which device comprises:
an injection nozzle with a nozzle body (3) and a nozzle needle (4) guided axially movably along a sliding surface (5) and having a sealing seat (7) provided with injection holes (8),
a nozzle holder fixed to the injection nozzle, with a nozzle-holding body (1), which is provided with a needle-spring space (16) and a needle-closing spring (14) disposed therein, as well as
a fuel high-pressure system, which is composed of a nozzle-side pressure line (6) that leads to the injection holes (8) and a holder-side pressure line (12) that opens thereinto and that is in communication with an inlet (11) arriving from an injection pump, wherein
the nozzle needle (4) is on the one hand urged onto its sealing seat (7) by the spring force of the needle-closing spring (14) and is on the other hand lifted from its sealing seat (7) when the pressure of the fuel conveyed thereto via the nozzle-side pressure line (6) exceeds the spring force of the needle-closing spring (14), characterized by the features:
the nozzle-holding body (1) is provided with a cavity (“valve-spring space”) (26), which is in communication with the fuel high-pressure system (12, 6) via a connecting line (27),
the cavity is in communication with the needle-spring space (16) via a first pressure valve (18, 19) and a second pressure valve (21, 22),
the first pressure valve opens toward the needle-spring space (16), and is provided with a valve body (18), which on the one hand is urged onto its sealing seat (19) by the spring force of the needle-closing spring (14) and on the other hand can be lifted from its sealing seat (19) by the pressure in the connecting line (27), whereby fuel flows from the valve-spring space (26) into the needle-spring space (16),
the second pressure valve opens toward the valve-spring space (26), and is provided with a valve body (21), which on the one hand is urged onto its sealing seat (22) by the spring force of a weak valve spring (23), boosted by the pressure in the connecting line (27), and on the other hand can be lifted from its sealing seat (22) by the pressure of the fuel in the needle-spring space (16), whereby fuel flows from the needle-spring space (16) into the valve-spring space (26).

2. A fuel-injection device according to claim 1, characterized in that
the second constant-pressure valve is integrated in the first constant-pressure valve.

3. A fuel-injection device according to claim 2, characterized by the features:
between the needle-spring space (16) and the valve-spring space (26), the valve body (18) of the first constant-pressure valve is provided with an axial shaft (20), whose outside is provided with grooves (28) for guiding fuel,
the valve body (18) and the shaft (20) are provided with a through-bore (29), which is open at its end next to the needle-spring space, and is closed at its end next to the valve-spring space (26) by a ball (21) urged against its sealing seat (22) by the spring force of the valve spring (23).

4. A fuel-injection device according to claim 1, characterized in that
the valve spring (23) is disposed in the valve-spring space (26).

5. A fuel-injection device according to claim 4, characterized in that the valve spring (23) is braced against a sealing plug (25), which seals the valve-spring space (26) from the outside.
